(19) United States
(12) Patent Application Publication
(10) Pub. No.: US 2010/0301650 A1
(43) Pub. Date: Dec. 2, 2010

(54) LUMBAR SUPPORT FOR A CAR SEAT

(76) Inventor: Cheong Myung Hong, Goyang-si (KR)

Correspondence Address: KIRTON AND MCCONKIE, 60 EAST SOUTH TEMPLE,, SUITE 1800, SALT LAKE CITY, UT, 84111, US

(21) Appl. No.: 12/577,561

(22) Filed: Oct. 12, 2009

(30) Foreign Application Priority Data
May 27, 2009 (KR) 10-2009-0046363

(51) Int. Cl. B60N 2/66; A47C 7/46

(52) U.S. Cl. 297/284.8

(57) ABSTRACT

A lumbar support for a car seat according to the present invention comprises a pair of coupling elements, respectively coupled with traverse fixing bars provided in internal upper and lower parts of a seat back; a pair of support plates provided on right and left sides between a pair of the coupling elements and respectively having a plurality of support wings; a support element including a sacrospinal muscle base at a lower part thereof; and a supporting height control element provided on one side of the support plate to alternatively control a protrusion height of the support plates; wherein the support element further includes a lumbar vertebra base integrally formed in an upper part of the sacrospinal muscle base.

### BACKGROUND OF THE INVENTION

1. Field of the Invention

The present invention relates to a lumbar support for a car seat which may stably support the lumbar vertebra and sacrospinal muscles of a passenger sitting in a car seat, and more particularly to a lumbar support for a car seat, in which a sacrospinal muscle base and a lumbar vertebra base are integrally formed in upper and lower parts of support plates, which are positioned between traverse fixing bars provided in upper and lower parts in a seat back, so as to improve the close contact between the seat and a passenger, increase the seating comfort of the passenger by improving static seating comfort, and prevent the vertebral column of the passenger from being applied with an overload due to the bad posture of the passenger.

2. Description of Related Art

In general, a driver's seat and a passenger's seat next to the driver's seat are separated from each other via a console box. The seats are designed in consideration of seating comfort with minimized fatigue by absorbing the vibration from the road surface, thereby supporting the driver or the passenger properly. Further, the seats occupy a relatively large portion in the weight and cost of the whole vehicle, so that the design thereof should be performed in consideration of the lightweight and economical structure.

In addition, the seat needs more designing requirements such as static seating comfort for a passenger to sit therein in a stabilized posture finally, the comfort of the passenger with relation to the vibration characteristics of the seat, that is, the dynamic seating comfort, and hold performance for protecting the passenger in the seat at the time of turning or winding road running of the car.

A lumbar support is fixed to traverse fixing bars mounted in the seat and includes support plates for supporting the lumbar vertebra of a passenger and a controller for controlling the support plates.

The lumbar support varies the supporting force for the lumbar vertebra of the passenger for the purpose of fatigue reduction and health keeping during a long term driving.

Therefore, the lumbar support may provide the passenger with static seating comfort for finally realizing a stabilized posture when the passenger is sit in the seat, the comfort resulted from the vibration characteristics of the seat, that is, the dynamic seating comfort, and hold property for protecting the passenger in the seat at the time of turning or winding road running of a car.

The prior art lumbar support is mounted in a seat back and alternatively and curvedly protruded so as to effectively support the lumbar vertebra of a passenger. The prior art lumbar support has, however, a disadvantage that the curvedly protruded support plates can support only a part of the lumbar vertebra of a passenger so that the lumbar vertebra may be overloaded.

In other words, if the passenger is supported at only a part of the lumbar vertebra, a waist disc of the passenger becomes pushed and nerves are pressed or stimulated in the case of long term driving, so that the whole waist and back of the passenger may be stiffened in the human body structure. If the passenger pushes his hips forward to resolve the stiffness, unstable posture may be induced, possibly further applying an overload to the vertebrae of the passenger.

Furthermore, if the unstable posture is kept long, spondylolysis, disc ailment, scoliosis or the like may be induced.

By all the above-mentioned reasons, the passenger may finally lose the static seating comfort to keep the stabilized posture in the seat, and be likely to feel fatigue, inducing falling asleep at the wheel or the like, which threatens the stability and the safety of the passenger.

### BRIEF SUMMARY OF THE INVENTION

Therefore, the present invention has been accomplished in order to solve the above-mentioned problems, and an object of the present invention is to provide a lumber support for a car seat with the improved seating comfort of a passenger, in which close contact between a seat and the passenger sitting in the seat may be improved by supporting the lumbar vertebra and sacrospinal muscles of the passenger sitting in the seat stably, and prevent fatigue in spite of long term driving.

Another object of the present invention is to provide a lumber support for a car seat with improved safety of a passenger, which may prevent a passenger from losing his posture in the seat by stably supporting the lumbar vertebra and sacrospinal muscles of the passenger and protecting the passenger from external shock.

In order to achieve the above and any other objects of the present invention, a lumber support for a car seat comprises:

a pair of coupling elements, respectively coupled with traverse fixing bars provided in internal upper and lower parts of a seat back;

a pair of support plates provided on right and left sides between a pair of the coupling elements and respectively having a plurality of support wings;

a support element including a sacrospinal muscle base at a lower part thereof; and

a supporting height control element provided on one side of the support plate to alternatively control a protrusion height of the support plates;

wherein the support element further includes a lumbar vertebra base integrally formed in an upper part of the sacrospinal muscle base.

It is preferable that leaf springs are connected to rear parts of the support plates to be elastically deformable.

According to the present invention as constructed above, in a lumber support for a car seat, a sacrospinal muscle base and a lumbar vertebra base are formed at upper and lower parts of the support plates for stably supporting the lumbar vertebra and sacrospinal muscles of a passenger sitting in a seat, so that close contact between the seat and the passenger sitting in a seat may be improved. Further, the lumber support for a car seat prevents the passenger from feeling fatigue for promoting safe driving.

In addition, the passenger may keep stable posture in the seat via the stable support for the lumbar vertebra and sacrospinal muscles of the passenger.

Therefore, the lumber support for a car seat may advantageously promote the health of the passenger.

### BRIEF DESCRIPTION OF THE DRAWINGS

The objects, features and advantages of the present invention will be more clearly understood from the preferred embodiment in the following detailed description in conjunction with the accompanying drawings, in which:

FIG. 1 is a perspective view showing the shape of a lumbar support according to a preferred embodiment of the present invention.

FIG. 2 is a disassembled perspective view showing the state that a leaf spring is coupled with the lumbar support according to the present invention.

FIG. 3 is a front view showing the state that the lumbar support is mounted to traverse fixing bars of a seat according to the present invention.

FIG. 4 is a side view showing the operation relationship between a lumbar support and a supporting height control element according to the present invention, and

FIG. 5 is a view showing the state that a supporting element of the lumbar support supports the lumbar vertebra and sacrospinal muscles according to the present invention.

### DETAILED DESCRIPTION OF THE PREFERRED EMBODIMENTS

Now, the lumber support for a car seat according to a preferred embodiment of the present invention will be described in more detail with reference to the accompanying drawings.

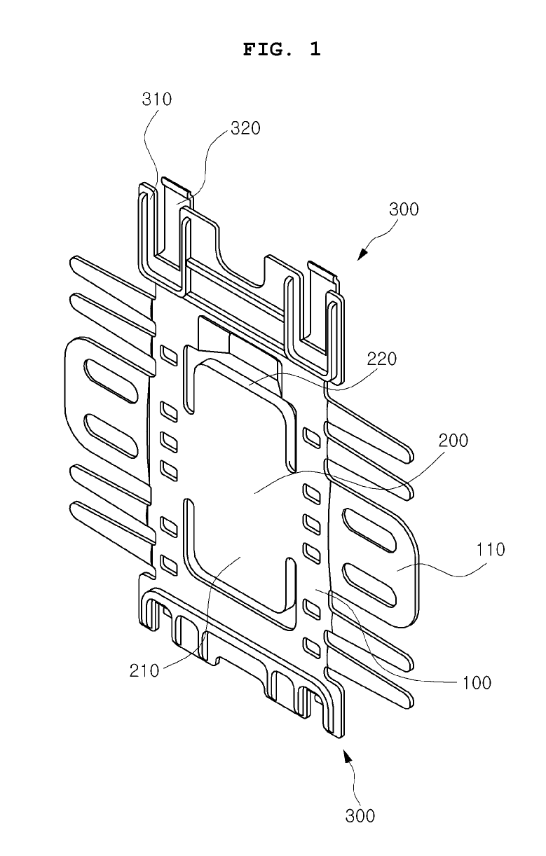

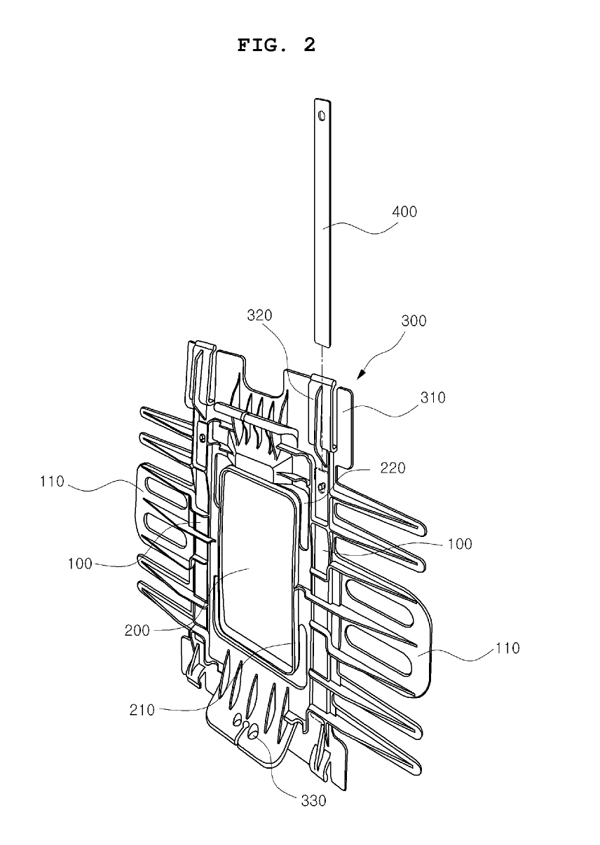

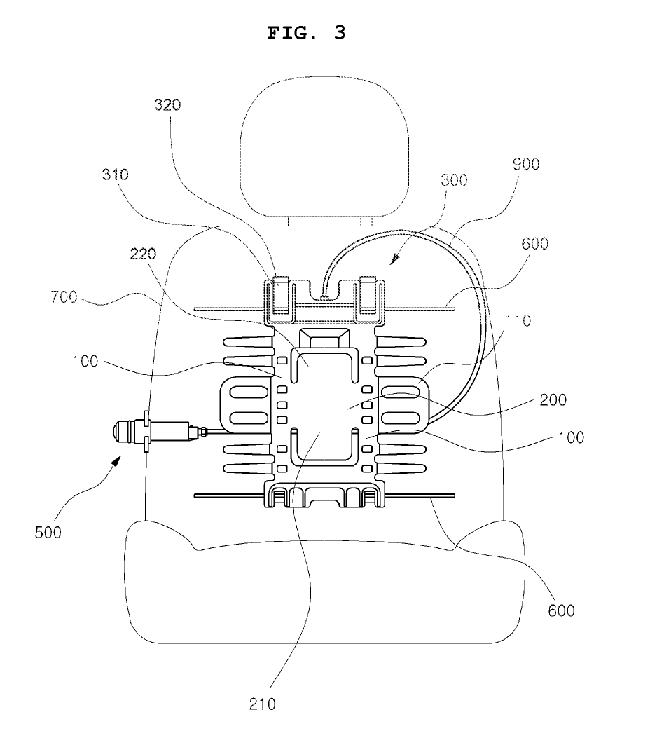

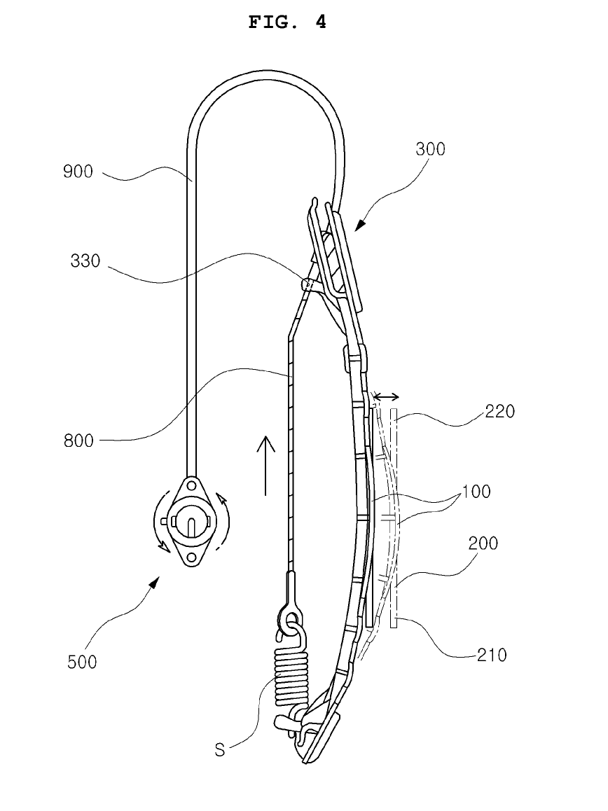

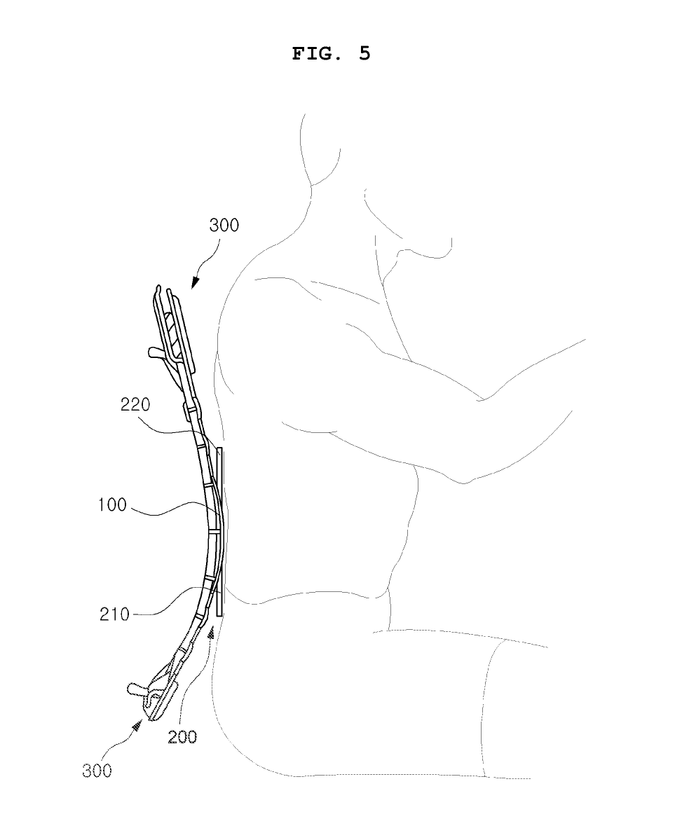

FIG. 1 is a perspective view showing the shape of a lumbar support according to a preferred embodiment of the present invention, FIG. 2. is a disassembled perspective view showing the state that a leaf spring is coupled with the lumbar support of the present invention, FIG. 3 is a front view showing the state that the lumbar support is mounted to traverse fixing bars of a seat according to the present invention, FIG. 4 is a side view showing the operation relationship between a lumbar support and a supporting height control element according to the present invention, and FIG. 5 is a view showing the state that a supporting element of the lumbar support supports the lumbar vertebra and sacrospinal muscles according to the present invention.

The lumbar support of a car seat according to the present invention, as shown in FIG. 1 to FIG. 5, is to reduce fatigue for a long term riding and to improve seating comfort via good posture kept by the lumbar support mounted in a seat back 700, and includes support plates 100 formed of leaf spring materials having high elasticity for absorbing shock and vibration, coupling elements 300 for mounting the supporting plates 100 to traverse fixing bars 600 at upper and lower parts in the seat back 700, and a support element 200 integrated into the supporting plates 100 at both side end parts in the center so as to form a lumbar vertebra base 220 and a sacrospinal muscle base 210 respectively at upper and lower parts thereof respectively.

The support plates 100 are coupled with leaf springs 400 for elastic deformation at rear parts, as shown in FIG. 2, and a plurality of support wings 110 are folded outside the support plates 100 for surrounding and supporting the waist of a passenger.

The coupling elements 300, which couple the support plates 100 with the traverse fixing bars 600 at upper and lower parts in the seat back 700, are integrally formed at upper and lower parts of the support plates 100.

At this time, coupling plates 310 are formed with folded coupling clips 320 in the center thereof, wherein the coupling clips 320 may be spread out for forming gaps so that the coupling plates 310 may be fitted with the traverse fixing bars 600 via the gaps formed at both sides of the coupling plates 310 so as to be coupled with traverse fixing bars 600.

At this time, the gaps formed by the coupling clips 320 spreading out from the coupling plates 310 are equal to or smaller than at least the thickness of the traverse fixing bars 600, and the coupling clips 320 have elasticity between the coupling plates 310. Therefore, the lumbar support cannot move out of the traverse fixing bars 600 in spite of vibration or shock of a car once the traverse fixing bars 600 are fitted between the coupling plates 310 and the coupling clips 320.

The coupling elements 300 formed of the coupling clips 320 and the coupling plates 310 are symmetrically formed in the same structure at upper and lower parts of the support plates 100 in order to prevent the lumbar support from deviating out of the traverse fixing bars 600 by the weight of passengers or external shock after the lumbar support is mounted to the traverse fixing bars 600.

Further, connection grooves 330 are formed in the center of the coupling elements 300 for fixing ends of a wire element 800 and a cable 900 surrounding the wire element 800 when the support element 200 is protruded by the manipulation of a support height control element 500, wherein the wire element 800 passes through the connection grooves 330.

Further, a spring element S is mounted between the wire element 800 and the center portion of the lower coupling element 300 for keeping the tension of the wire element 800 elastically.

Therefore, as shown in FIG. 4 and FIG. 5, as the support plates 100 are alternatively and curvedly folded to be protruded via the stepless control of the support height control element 500, the support wings 110 are curved while surrounding the waist of a passenger sitting in the seat, and the support element 200 is protruded for the lumbar vertebra base 220 and the sacrospinal muscle base 210 to support the lumbar vertebra and sacrospinal muscles of the passenger.

At this time, the sacrospinal muscle base 210 and the lumbar vertebra base 220 constituting the support element 200 are respectively integrated into the support plates 100 at both side ends in the middle of the support element 200, so as to keep a predetermined protrusion angle even when the support plates 100 are curvedly protruded to a side by the supporting height control element 500.

Therefore, if the passenger controls the supporting height control element 500 steplessly according to the body conditions of the passenger after sitting in the seat, the support plates 100 become protruded to a side and the support element 200 supports the passenger in such a manner that the lumbar vertebra base 220 supports the lumbar vertebra of the passenger and the sacrospinal muscle base 210 supports the sacrospinal muscles of the passenger.

At this time, the support element 200 is connected to the support plates 100 at both sides in the middle part, and includes the sacrospinal muscle base 210 at a lower part and the lumbar vertebra base 220 at an upper part as free ends, so that the sacrospinal muscle base 210 at the lower part and the lumbar vertebra base 220 at the upper part keep their protrusion states uniformly by the supporting height control element 500 regardless of whether the support plate 100 is curved or not.

In other words, even though the passenger selectively controls the protrusion angle of the support plates 100, the sacrospinal muscles and the lumbar vertebra of the passenger may be continuously supported by the sacrospinal muscle base 210 and the lumbar vertebra base 220.

Conclusionally, the sacrospinal muscles and the lumbar vertebra of the passenger may be simultaneously supported by the curvedly protruded support plates 100, the sacrospinal muscle base 210 and the lumbar vertebra base 220, so that the passenger may be in the stabilized posture finally when he sits in the seat and the close contact between the passenger and the seat may be improved.

Therefore, the passenger is guaranteed for safe and stable driving and healthy conditions with reduced fatigue for a long time driving.

What is claimed is:

1. A lumber support for a car seat, comprising:
a pair of coupling elements, respectively coupled with traverse fixing bars provided in internal upper and lower parts of a seat back;
a pair of support plates provided on right and left sides between a pair of the coupling elements and respectively having a plurality of support wings;
a support element including a sacrospinal muscle base at a lower part thereof; and
a supporting height control element provided on one side of the support plate to alternatively control a protrusion height of the support plates;
wherein the support element further includes a lumbar vertebra base integrally formed in an upper part of the sacrospinal muscle base.

2. A lumber support for a car seat as claimed in claim 1, wherein leaf springs are connected to rear parts of the support plates to be elastically deformable.
